(19) United States
(12) Patent Application Publication
(10) Pub. No.: US 2017/0255746 A1
(43) Pub. Date: Sep. 7, 2017

(54) AGGREGATING AND COMMUNICATING MEDICAL RECORDS

(71) Applicant: Edward Worthington, II, Maple City, MI (US)

(72) Inventor: Edward Worthington, II, Maple City, MI (US)

(21) Appl. No.: 15/057,731

(22) Filed: Mar. 1, 2016

(51) Int. Cl. G06F 19/00; G06F 17/30

(52) U.S. Cl. CPC G06F 19/322; G06F 17/30289

(57) ABSTRACT

The aspects disclosed herein provide various systems for aggregating and communicating health care records, and combinations thereof. The aspects disclosed herein included methods and techniques for receiving health care information, organizing the health care information, and communicating the health care information to relevant stakeholders. Thus, employing the aspects disclosed herein, health care is efficiently and optimally provided to the various parties associated with the responsibility of health care provision.

### BACKGROUND

Traditionally, health services have been provided by a single provider to a recipient, such as a patient. Thus, a patient would go to a clinic or hospital in which the patient is a member of, and obtain health-related services.

More recently, health care has been provided by networks. The networks allow a patient to go to various locations, such as pharmacies, clinics, hospitals and the like, and receive various health needs.

The networks may be geographically isolated, for example, in a city or county. Some health care networks may be national, or serve a larger scope. In either case, patients are likely to go to a variety of labs, clinics, and hospitals to satisfy a variety of health care needs. Further, patients are likely to attend a variety of locations and regions. For example, a patient may visit health care providers in multiple cities, counties, or states.

Conventionally, a patient would go to a single health care provider, and receive health care services from that single provider. As such, the single health care provider would contain a lion share of the information associated with a doctor or another professional associated with health care provision.

Due to the numerous locations and/or providers, obtaining a whole history of a patient now may be difficult. A single patient may be associated with more than one health care provider, and thus, the single patient may be required to provide the present health care provider with all the information associated with previous visits.

Further, even if the single patient is able to provide the health care provider with all the information associated with previous visits, the health care provider is responsible with retrieving all the information, as well as parsing through all the information to determine important information associated with patient care.

In recent times, new data standards associated with recording health care visits have been proposed. One such example is the admit-discharge-transmit (ADT) system. The ADT system is a record associated with each visit to a health care provider. The health care provider may be a clinic, a hospital, a pharmacy, or some other affiliated service associated with the provision of health care services to a patient.

In many health care systems and networks, any time a service associated with health care is provided, an ADT data file may be generated. However, as mentioned above, an ADT data file may be generated for a routine service or for a service associated with critical information (i.e. information that may be necessary or helpful for future health care providers).

### SUMMARY

Systems and methods for providing, aggregating, receiving and communicating health records are provided herein. The systems and methods allow health care organizations and providers to effectively improve the dissemination and communication of health information. As this sort of systems and methods currently are not known, the aspects disclosed herein provide a new methodology for the dissemination of health care records, while allowing multiple health care networks to effectively work together.

### DESCRIPTION OF THE DRAWINGS

The detailed description refers to the following drawings, in which like numerals refer to like items, and in which:

FIG. 1 illustrates an example of a chart according to an overall concept disclosed herein.

FIG. 2 illustrates an example of a system for receiving health care records according to the aspects disclosed herein.

FIG. 3 illustrates an example of a method describing the system in FIG. 2.

FIG. 4 illustrates an example of a sample health care record employable with the aspects disclosed herein.

FIG. 5 illustrates an example implementation of system for processing received information from the system in FIG. 2.

FIG. 6 illustrates a method describing the system of FIG. 5.

FIG. 7 illustrates an example of a lookup table being employed with the systems disclosed herein.

FIG. 8 illustrates an example of a system for communicating the processed information of FIG. 5.

FIG. 9 illustrates a method describing the system of FIG. 8.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

Being cognizant of a patient's history with a number of health care providers greatly improves the quality of service received, as well reduces costs. If a whole history is known by, for example, a doctor or other health care provider, the health care provider is able to provide better, cheaper, and more efficient health services.

In order to provide this information, a general database would have to be implemented. However, these generalized databases are not possible due to privacy concerns, format compatibility issues, and the mere fact that the information provided would be unusable.

For example, if all information associated with a patient were available from a generalized database, the information may not be usable by a health care provider due to the mere fact that much of the information would be useless.

Disclosed herein are methods and systems for aggregating and communicating medical records. Because existing systems do not deal with real-world issues associated with how medical services are provided, existing systems and methods are deficient for handling the needs and desires of health care providers.

The aspects disclosed herein provide methods and systems that create new ways of allowing health care to be efficiently disseminated. Thus, health care providers, patients, and other stakeholders are given a more efficient way of interacting with the available resources associated with a health care provision.

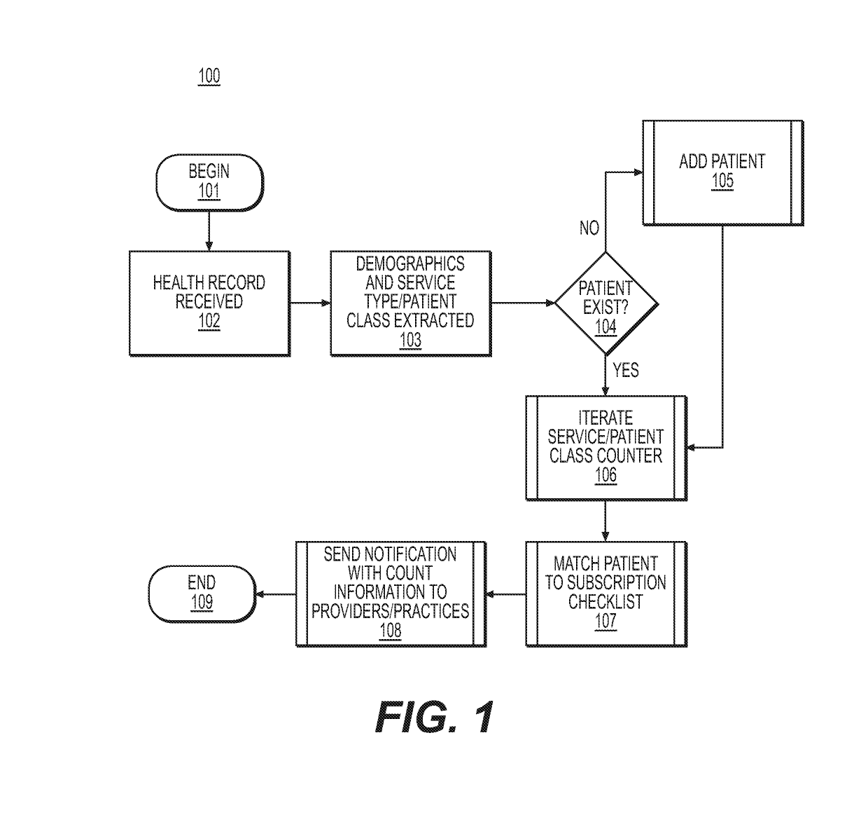

FIG. 1 illustrates an example of a chart 100 according to the overall concept disclosed herein. The chart 100 depicts a sample implementation of how information is propagated employing the aspects disclosed herein. The systems shown herein may be modified by the implementater of a health care network, health information exchange (HIE), or the like.

In response to a beginning operation 101 (either through a manual, automatic, or period time based instruction), a health record is received in operation 102. The health record may be any known health records employed by one of ordinary skill in the art, for example, the ADT-type described above.

In operation 103, information is extracted. Often times, the health record is anonymized to remove information associated with personal identification. In certain cases, the health records are anonymized based on various jurisdictional requirements, such as HIPAA and the like. At operation 103, for example, information associated with the health record may be extracted, such as: the demographics, service type, patient class, and the like.

In operation 104, a determination is made as to whether the patient exists based on the extracted information. If the extracted information indicates that the patient exists, the method shown in FIG. 1 proceeds to operation 106. If no, the patient is added to a list of patients (105).

In operation 106, the records associated with the identified patient (104), or the newly added patient (105), are iterated by one. Thus, the type of service the patient is associated with (i.e., the type of visit, test, operation, provider seen) is added by one.

In operation 107, the patient identified or added in operation 106 is matched to a subscription list associated with that patient. This list indicates what sources, health care providers, and the like are authorized to receive information about this patient. This matching can further be demarcated by selecting classes or categories of services that the sources/health care providers are authorized to receive information about.

In operation 108, a notification of the information generation in operation 107 is made available to the various sources/health care providers. In some cases, the notification may be automatically transmitted to the sources/health care providers. In other cases, the notification may be made available in response to a request for information. As such, the process in FIG. 1 ends (109), and may be employed to aggregate and communicate further information based on received health records.

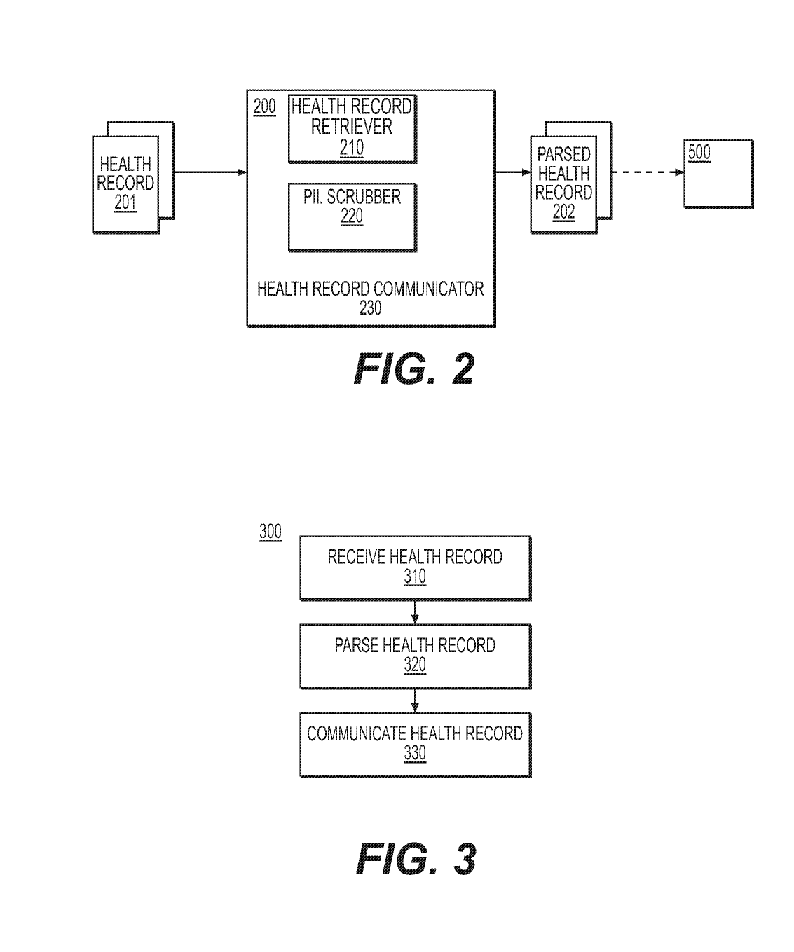

FIG. 2 illustrates an example of a system 200 for receiving health care records according to an aspect disclosed herein, and FIG. 3 illustrates a method 300 explaining how the system 200 operates. The system 200 may interface with the other systems shown and discussed herein. The system 200 is likely to be placed in a health care provider or other client-side point associated with health care provision. In other situations, the system 200 may be implemented in an intermediary location or environment, i.e., a location not responsible for direct care for a patient.

The system 200 includes a health record retriever 210, a personal identification information (PII) scrubber 220, and a health record communicator 230. The system 200 may be implemented in a computing device, or alternatively, through some sort of system to process health records.

The system 200 receives a health record 201 via the health record retriever 210 (via operation 310). The health record 201 represents a single provision of health care services associated with a patient. This can vary from the admit process, the discharge process, or other events associated with the provision of health care. The health record 201 includes the name of the patient, other identifying information (for example, age, address, race, etc), the service being provided, and the like. The health record 201 may be automatically generated at a location in which the system 200 is implemented, or manually entered by an agent associated with the provision of health care.

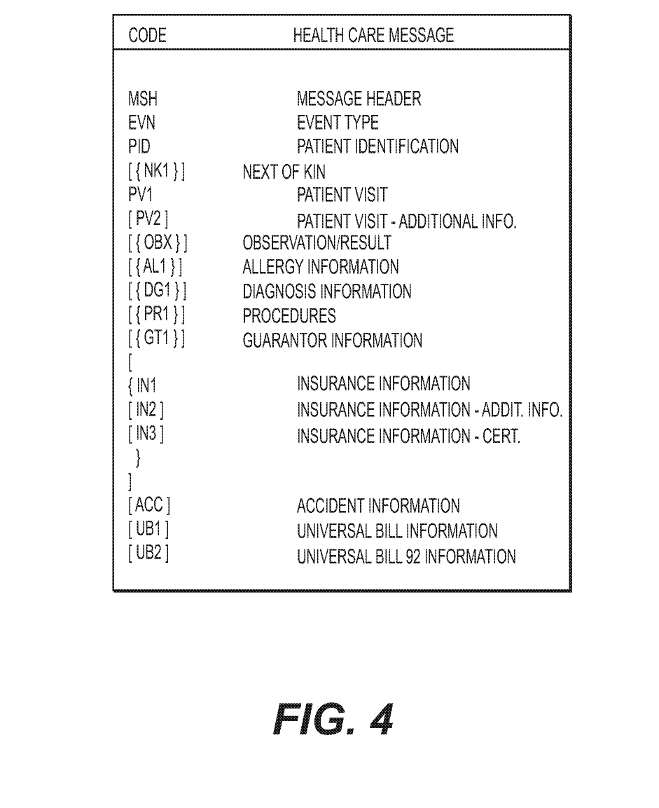

The Health record parser 220 (in operation 320), is configured to parse the health record information 201 to obtain the relevant information employable by the other systems disclosed herein. Thus, the name and other specifics that would allow another party to identify the patient are retrieved. For example, as shown in FIG. 4, a sample record is shown. In the record shown, the relevant information may be predefined, for example, the ‘PATIENT IDENTIFICATION’, ‘the PATIENT VISIT’, and other demographic information, such as age, cities, and other identifying or usable characteristics.

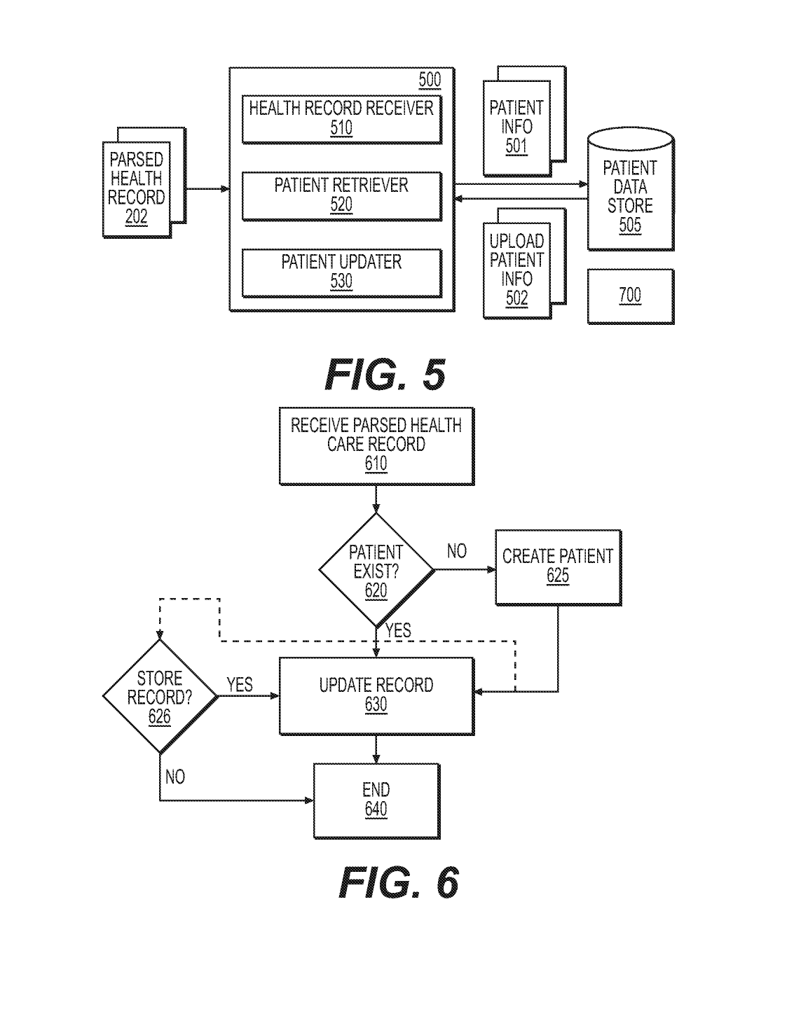

The health record communicator 230 (in operation 330), communicates the parsed health record 202 to a receiving party, such as the system 500 disclosed herein (which will be described in greater detail in FIG. 5).

FIG. 5 illustrates an example of a system 500 for processing received information, for example, parsed health care information 202 from system 200. FIG. 6 illustrates an example method 600 explaining the operation of system 500. System 500 includes a health record retriever 510, a patient retriever 520, and a patient updater 530. The system 500 communicates with a data store 505 (which may be any electronic or non-electronic device or technique to store information).

The health record retriever 510 is configured to receive parsed health care records from a source (operation 610). For example, the source may be system 200 as described in FIG. 2, communicating the parsed health care record 202 to system 500.

The patient retriever 520 is configured to retrieve (or create) information about the patient associated with the parsed health care record 202. As explained by operations 620 to 630, patient information is selected to be updated, or alternatively, created. In operation 620, a determination is made as to whether the patient exists. For example, the patient data store 505 may store patient information 501. The patient information 501 may be retrieved from the patient data store 505, and compared against to make the determination of operation 630.

If yes, the method 600 proceeds to operation 630. If no, the method 600 proceeds to operation 625, where a record associated with patient identified by parsed health care record 202 is identified.

In an alternative implementation of system 500 and method 600, the method 600 may proceed after operation 620 to operation 626. In operation 626, a determination is made as to whether the record and/or information associated with the record is to be stored. If yes, the method proceeds to operation 630. If no, the method 600 is ended 640. In this manner, the implementer of system 500 may elect to filter or determine which categories of records to store.

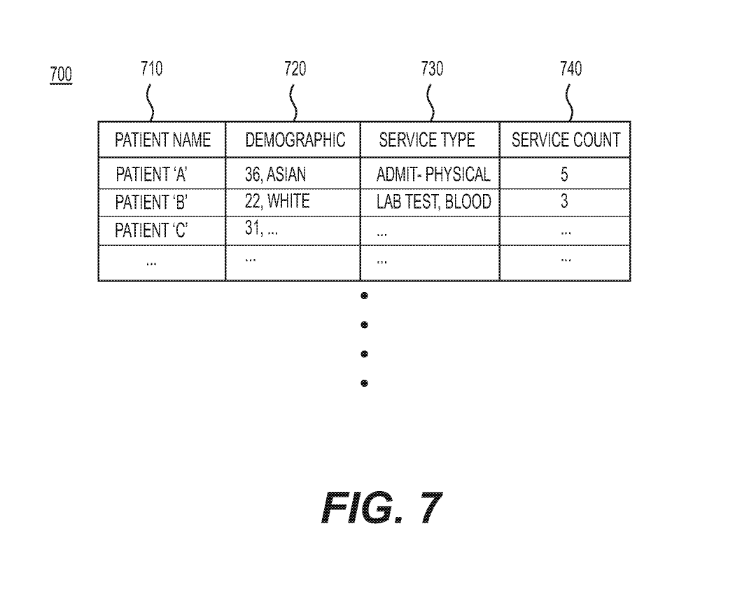

The patient updater 530 is configured to update a record/data associated with the patient (operation 630). Accordingly, updated patient information 502 may be communicated to the patient data store 505, and thus, be employed to update data about the patient associated with parsed health care record 202. As shown in FIG. 7, lookup table 700 includes an example of information associated with the operations/system described herein.

The lookup table 700 includes various fields 710, 720, 730 and 740, each populated with sample data. The fields implemented are purely exemplary, and may be modified employing the core concepts and ideas disclosed herein.

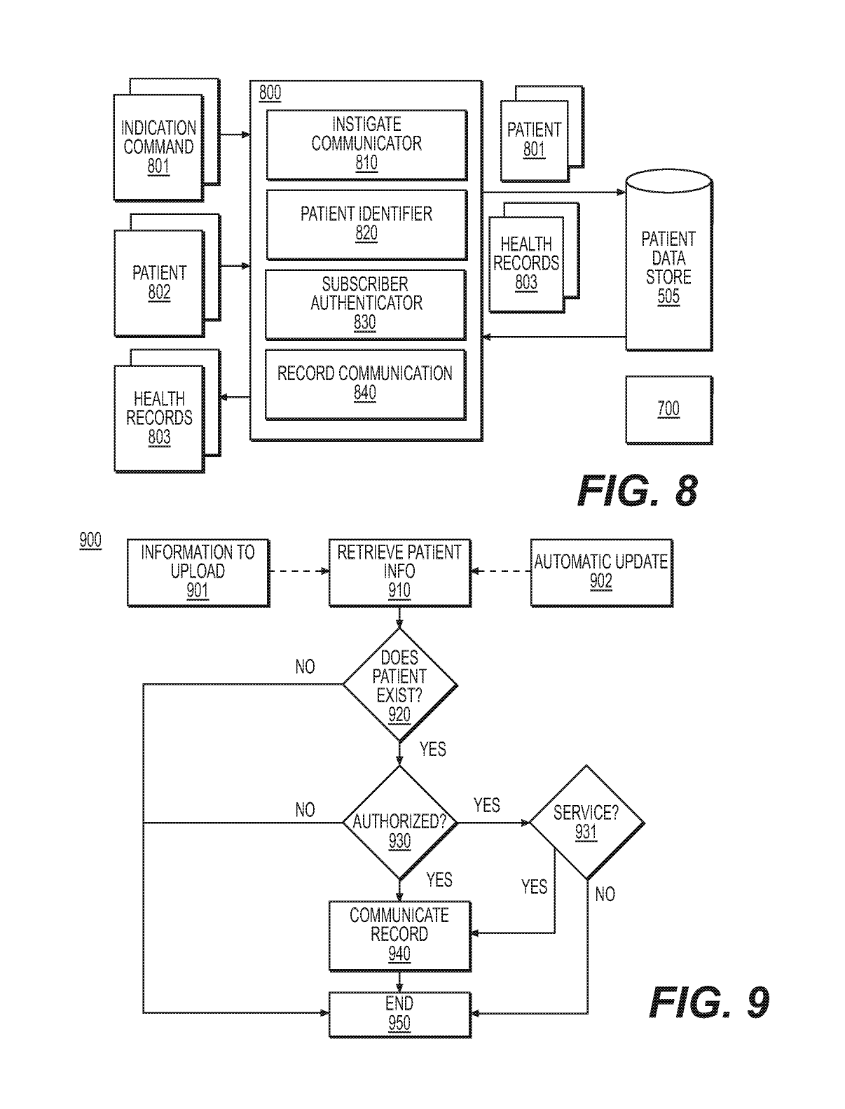

FIG. 8 illustrates an example of a system 800 for communicating the processed information of FIG. 5. The system 800 includes an instigate communicator 810, a patient identifier 820, a subscriber authenticator 830, and a record communicator 840. The system 800 may be implemented in a centralized location, and be in communication with a variety of health care providers. The system 800 is explained via FIG. 9, as illustrated via method 900.

In operation 910, the instigate communicator 810 receives an indication 801 to start communicating information to a subscriber (for example, a health care provider or other party explained above). Additionally, the system 800 receives information about the patient 802 as well.

As illustrated in FIG. 9, the instigation may occur in alternate manners. In operation 910, instruction from a subscriber may be communicated to system 800. Alternatively, the system 800 may be configured to automatically communicate the update health care records to a predetermined list of authorized subscribers (902).

The patient identifier 820 is configured to determine whether the patient 802 is exists or has records associated with the patient (920). If no, the method 900 proceeds to operation 950. If yes, the method 900 proceeds to operation 930.

As shown in FIG. 8, the patient identifier 820 communicates the patient 802 to the patient data store 505. Accordingly, the lookup table 700 may be referred to determine whether the patient 802 is associated with previously created health records.

The subscriber authenticator 830 (which is explained in operations 930 and 931), determines whether the subscriber associated with the patient 802 request is authorized. If no, the method 900 proceeds to end 950. If yes, the method 900 proceeds to operation 940, where the record communicator 840 is configured to communicate the retrieved health record 803 associated with the patient 802 to the requesting, or configured to be communicated to, subscriber.

Alternatively shown is operation 931, which provides a secondary set of authentication. Each subscriber may be selectively authenticated for some services associated with health care provision, and not be authenticated for other. In operation 931, a determination is made as to whether information being communicated to the subscriber is allowed, and if not, this information is not permitted and blocked from being sent. As such, the authorized services (for example, as shown in field 730), may be communicated.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

We claim:

1. A method for aggregating health care records, comprising:
receiving a health care record from a health care provider;
determining whether a patient associated with the health care record exists;
in response to the patient's health care record not existing, creating a record associated with the patient;
in response to the patient's health care record existing, updating a count associated with a service identified in the received health care record.

2. The method according to claim 1, wherein the health care record is associated with parsed information, the parsed information being an existing health care record stripped of a predetermined set of data.

3. The method according to claim 1, wherein the updated count includes services of a same type performed by multiple health care providers.

4. The method according to claim 3, wherein the multiple health care providers are in different health care networks.

5. A method for communicating health care records, comprising:
receiving an instigation request for a patient from a subscriber;
determining whether the patient corresponds to an existing patient in a maintained record of patients;
in response to the patient corresponding to at least one of the existing patients, retrieving a set of records associated with the patient and at least one service associated with the patient; and
communicating the set of the records to the subscriber.

6. The method according to claim 5, wherein the retrieving further comprises an authentication process to determine whether the subscriber is authorized to receive records associated with the patient.

7. The method according to 6, wherein the retrieving further comprises a second authentication process, to determine whether the subscriber is authorized to receive records of the service associated with the patient.

8. The method according to claim 5, wherein the instigation request is originated from a request sourced from the subscriber.

9. The method according to claim 5, wherein the instigation request is configured to communicate an updated record in response to the patient receiving the service.

10. The method according to claim 5, wherein the instigation request is configured to communicate an updated record in response to a predetermined time elapsing.
